(19) United States
(12) Patent Application Publication
(10) Pub. No.: US 2011/0126778 A1
(43) Pub. Date: Jun. 2, 2011

(54) RETRACTABLE PET LEASH WITH SELF POWERED ELECTRIC LIGHT

(76) Inventor: Lucy A. Mitchell, Melksham (GB)

(21) Appl. No.: 13/023,002

(22) Filed: Feb. 8, 2011

Related U.S. Application Data
(63) Continuation-in-part of application No. 11/598,386, filed on Nov. 13, 2006.

(51) Int. Cl. A01K 27/00; B65H 75/34; A01K 29/00; F21L 13/06

(52) U.S. Cl. 119/796

(57) ABSTRACT

A retractable pet leash having an integrated lamp powered by an electric generator. A spool is rotatably mounted inside a housing and a leash cord is coiled on the spool. The spool rotates in a first direction of rotation as the leash cord pays out through an opening provided in the housing. A spring inside the housing is configured to bias the spool toward rotation opposite the first direction of rotation, for retracting the leash cord. A circular toothed gear is attached to the spool for synchronous rotation and a set of speed change gears are configured to translate rotation of the circular toothed gear to turn the generator. A cup gear, having an inner wall provided with a unidirectional teeth groove, engages a speed change gear. A prism plate with pivotally mounted pawls is rotatably mounted in contact with the unidirectional teeth groove, for translating rotation in one direction only, to the generator. The generator outputs direct current to a circuit board. The circuit board includes a set of capacitors for storing electric potential and an electric filter for outputting a stable power supply to energize the lamp.

### CROSS-REFERENCE TO RELATED APPLICATIONS

This application is a Continuation-in-Part of application Ser. No. 11/598,386, filed on Nov. 13, 2006, which application is incorporated herein by reference in its entirety.

### BACKGROUND OF THE INVENTION

1. Field of the Invention

The present invention generally relates to retractable pet leashes, and more particularly, to a retractable pet leash having an integral self powered light source.

2. Description of the Prior Art

As populations increase, more people find themselves living in urban settings. Locations where pets, particularly dogs, can be allowed to exercise freely are becoming scarce and it is necessary to keep pets leashed at all times, when they are away from their owner's property. Some jurisdictions impose regulations requiring the use of a leash for pets. Retractable leashes have become popular because they allow a pet to quickly move to a distance several meters away from the owner but the owner can maintain control of the pet by holding the handle of the retractable leash. In this manner, the pet can run or play, when the situation permits a wider range of movement, while remaining on the leash. The owner can reign in the pet when the situation requires the pet to be at heel.

Typically, the retractable leash comprises a rigid housing, which contains a reel assembly for holding a coil of cord. One end of the cord is anchored to the reel assembly and the other end is attached to a collar worn by the pet. The reel assembly is rotatably mounted within the housing, so that the cord may be payed out from the rotating reel, as the pet moves away from the owner. An opening is provided in the housing, through which the cord passes. The reel is biased by a spring for reversely rotating the reel to retract the cord, when tension is released. In a situation where safe space is available for the pet to move away from the owner, the owner may allow the cord to pay out from the reel as the pet advances. When it becomes necessary to maintain the pet in close proximity to the owner, the owner advances toward the pet or calls the pet to come, and allows the reel to rotate reversely, urged by force of the spring, to retract the cord, as the distance closes between the pet and the owner.

Typically, retractable leashes are outfitted with a finger operated brake to prevent the pet from pulling the cord and moving away from the owner. The brake may be used to maintain a given scope of cord extending from the housing, when the situation warrants, such as the approach of another pet of uncertain temperament or the close proximity of traffic. The handle and the brake are configured so that the pet owner may maneuver the leash and operate the brake using one hand, leaving the other hand free, for other needs.

Many pet owners walk their pets during hours of darkness and it is often necessary to carry a portable light source, such as a flashlight, to light a walkway and to act as a beacon for approaching traffic. Often the free hand of the pet owner is occupied for carrying the portable light source. The need for an integrated retractable pet leash and portable light source has been answered by a combined retractable leash and battery powered flashlight. With this device, the pet owner may use one hand to operate the retractable leash and the flashlight. Some of these devices have been equipped with rechargeable batteries to reduce the risk of the pet and the owner being out after dark with a marginally effective light, because of weak batteries. While these devices add a measure of safety, if the retractable leash is religiously maintained on the charging system, the housing is somewhat bulky because of the need to accommodate the batteries and the charging system must remain in continuous operation, in the owner's home. A retractable leash, of this type, is disclosed in the U.S. Pat. No. to Matt, U.S. Pat. No. 6,003,472, and the patents cited therein.

There is a need for a retractable pet leash with an integrated self powered light source.

There is a need for a retractable pet leash with an integrated light source, which does not require batteries.

There is a need for a retractable pet leash with an integrated light source, and battery charging capability.

There is a need for a retractable pet leash having a conveniently compact design with a relatively thin profile.

### SUMMARY OF THE INVENTION

The present invention is directed toward a retractable pet leash with an integrated power supply and light source. The power supply is provided by a generator which produces electricity to operate the light. The retractable pet leash with self powered electric light comprises a housing, a leash cord, a reel assembly, a generator assembly, and a lamp. The housing is provided with a handle for grasping, to control the pet, and an opening through which the leash cord may pass. The reel assembly comprises a spool, which is rotatably mounted inside the housing, and a spring.

The leash cord is coiled on the spool and may be payed out through the opening, with rotation of the spool in a first direction. The leash cord has a first end, which is anchored on the spool and a second end, which is disposed outside the housing. The spring is mounted inside the housing and is configured to bias the spool toward rotation opposite the first direction of rotation, for retracting the leash cord onto the spool.

The generator assembly includes an electricity generator, mechanical transmission means and a circuit board. The mechanical transmission means are configured to operably connect the spool to the electricity generator, so that rotation of the spool turns the electricity generator, for producing electricity. The mechanical transmission means may include speed change gears, for adjusting the speed at which the generator turns relative to a given rotational speed of the spool. The mechanical transmission means may also include rotational direction interruption means configured to transmit only one direction of spool rotation to the generator, for producing a direct current output from the generator.

The circuit board is electrically connected to the output of the generator for receiving electric current into the circuit board. The circuit board includes power storage means and electric filtering means for outputting a stable power supply.

The lamp is mounted on the housing and includes electrical connection means for receiving the power supply and illumination means for producing light. During hours of darkness, a pet owner may grasp the handle and attach the second end of the leash cord to a collar worn by a pet. The owner may encourage rotation of the spool by repeatedly paying out and retracting the leash cord, as the pet moves between close and distant points in relation to the owner. The rotation of the spool turns the generator to produce electric power for operating the lamp to provide illumination for convenience of the pet owner. The power storage means may include a rechargeable battery or the power storage means may be designed without a battery.

In some embodiments, the present invention broadly comprises a retractable pet leash with a self powered electric light. The leash includes: a housing, having a handle and an opening; a leash cord, having a first end and a second end; a reel assembly having a first axial width and comprising a spool and a spring, the spool rotatably mounted inside the housing, the leash cord being coiled on the spool for paying out through the opening by rotating the spool in a first direction, the first end of the leash cord being anchored to the spool and the second end of the leash cord being disposed outside the housing, the spring being mounted inside the housing and being configured to bias the spool toward rotation opposite the first direction, for retracting the cord onto the spool; a generator assembly being mounted inside the housing and comprising an electric generator operably connected to the reel assembly and operably connected to a circuit board, the generator having a second axial width positioned substantially within the first axial width, the circuit board having an electric power storage means; and, a lamp mounted on the housing and being operably connected to the circuit board, whereby a user may attach a collar worn by a pet to the second end of the leash cord, grasp the handle to control the pet, and repeatedly extend and retract the cord to generate electricity for powering the lamp.

In other embodiments, the present invention broadly comprises a retractable pet leash with a self powered electric light. The leash includes: a reel assembly having a first axial width; a generator assembly comprising an electric generator operably connected to the reel assembly and operably connected to a circuit board, the generator having a second axial width positioned substantially within the first axial width, the circuit board having an electric power storage means; and, a lamp operably connected to the circuit board, whereby a rotation of the reel assembly generates electricity for powering the lamp.

It is an object of the present invention to provide a retractable pet leash with an integrated self powered light source.

It is another object of the present invention to provide a retractable pet leash with an integrated light source which does not require batteries.

It is a further object of the present invention to provide a retractable pet leash with an integrated light source and battery charging capability.

It is yet another object of the present invention to provide a retractable pet leash with an integrated self powered light source and a relatively thin profile.

These and other objects, features and advantages of the present invention will become more readily apparent from the attached drawings and the detailed description of the preferred embodiments, which follow.

### BRIEF DESCRIPTION OF THE DRAWINGS

The nature and mode of operation of the present invention will now be more fully described in the following detailed description of the invention taken with the accompanying drawing figures, in which:

FIG. 1 is a front perspective view of the retractable pet leash of the present invention;

FIG. 2 is an exploded view of the retractable pet leash of the present invention;

FIG. 3 is a left side view of the retractable pet leash of the present invention, with the housing cut away to display the inside space of the housing;

FIG. 4 is a right side view of the retractable pet leash of the present invention with the housing cut away to display the spool and the spring;

FIG. 5 is a perspective view of the retractable pet leash of the present invention in use, showing the leash in an extended position;

FIG. 6 is a right side view of another embodiment of the retractable pet leash of the present invention showing only the spool, leash and generator assembly;

FIG. 7 is a left side view of the embodiment of the retractable pet leash shown in FIG. 6 showing only the spool, spring, leash and generator assembly; and,

FIG. 8 is a top view of the embodiment of the retractable pet leash shown in FIG. 6 showing only the spool, leash and generator assembly with the housing shown in broken lines.

### DETAILED DESCRIPTION OF THE PREFERRED EMBODIMENTS

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

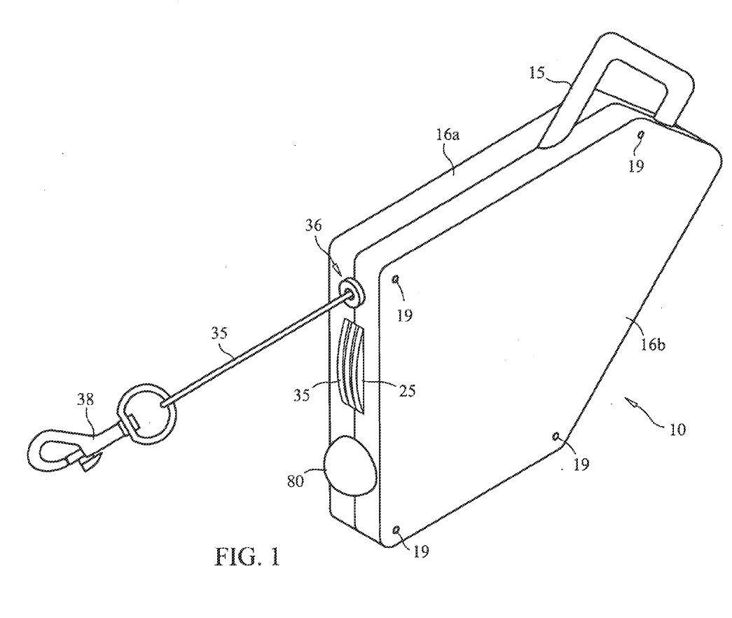

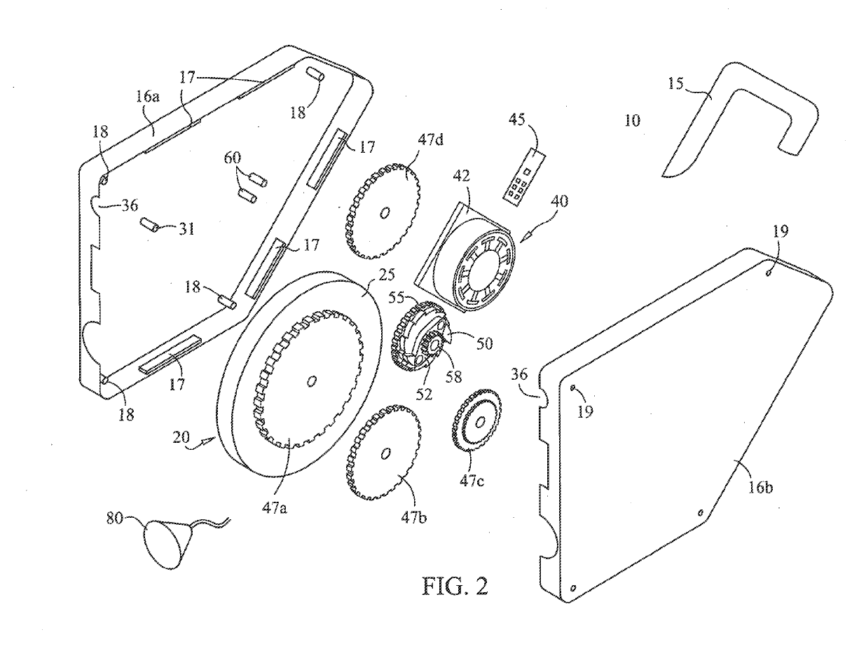

Shown throughout the drawings, the present invention is generally directed toward a retractable pet leash with a self powered electric light. The retractable leash of the present invention includes a housing 10 formed of rigid and durable material, such as plastic or metal, as shown in FIG. 1. A handle 15 is provided on the housing 10, for grasping the retractable pet leash. The housing 10 is preferably formed of paired half sections 16a and 16b having opposed flanges 17 as shown in FIG. 2, designed for overlapping engagement and threaded posts 18 and corresponding holes 19 joined by screws for retaining the half sections 16a and 16b in adjacent engagement, to define an inside space of the housing 10. The half section 16a forms a right side wall of the housing 10 and a portion of a front, back, top, and bottom. The half section 16b forms a left side wall and corresponding portions of the front, back, top, and bottom. Alternatively, the housing 10 may comprise other conventional enclosures of varying shapes and dimensions. The handle 15 may be formed integrally with the housing 10 or the handle 15 may be formed separately and attached. The same material used for forming the housing 10 is suitable for forming the handle 15. A reel assembly 20, preferably formed of metal or plastic, is rotatably mounted inside the housing, as shown in FIGS. 2, 3, and 4. The reel assembly 20 includes a spool 25 and a spring 30. It is preferred that the spool 25 be mounted on a axle 31 formed of two aligned segments, each extending from one of the half sections 16a and 16b across the inside space of the housing 10, to abut one another and confine the spool 25 in rotating engagement.

A flexible leash cord 35 is coiled onto the spool 25. Braided nylon cord having a diameter of approximately ⅛ inch and a length of approximately 25 feet is suitable. The leash cord 35 has a first end anchored to the spool 25 and a second end disposed outside the housing 10. An opening 36 is preferably provided in the front of the housing 10 through which the leash cord 35 may pass. The first end may preferably be anchored by a clamp crimped to the leash cord 35 and affixed to the spool 25 by a screw or by other conventional means. The second end is preferably provided with a fixed selectively releasable clasp 38, of conventional design, for attaching the leash cord 35 to a ring provided on a collar worn by a pet, in conventional fashion. The clasp 38 may act as a stop to prevent the leash cord 35 from retracting into the housing 10, or a conventional stop may be attached at an intermediate location on the leash cord 35. Applying tension at the second end causes the leash cord 35 to pay out through the opening 36 while rotating the spool 25 in a first direction of rotation.

The spring 30 is preferably a spiral wire spring mounted inside the housing 10 and configured to bias the spool for rotation in a direction opposite the first direction of rotation, as shown in FIG. 4. It is intended that the leash cord 35 may be forcibly payed out through the opening 36, rotating the spool 25 in the first direction of rotation increasing tension of the spring 30 as the spool 25 rotates, in the first direction of rotation.

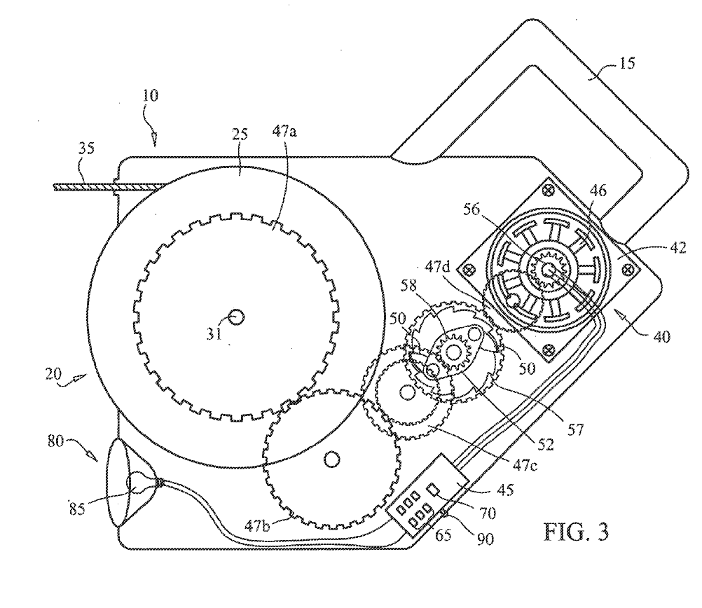

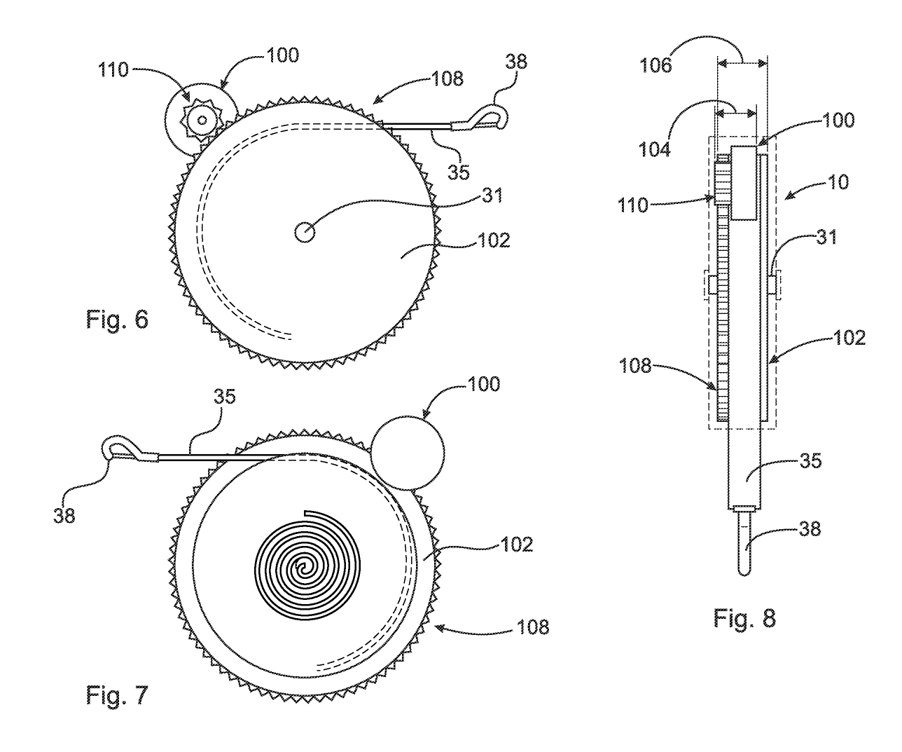

A generator assembly is mounted inside the housing 10 and includes an electric generator 40 mechanical transmission means and a circuit board 45, as shown in FIG. 3. Simplified embodiments of mechanical transmission means are discussed infra with reference to FIGS. 6 through 8. The generator 40 is provided with a mounting plate 42 of conventional design for securing the generator 40 inside the housing 10. The generator 40 is preferably a gear driven armature of wound conductive coils on a rotating spindle 46, of conventional design, disposed in a field of permanent magnets, configured to generate an output of electric power when the spindle 46 is turned. The mechanical transmission means includes a circular toothed gear 47a attached to said spool 25 for synchronous rotation about the axis of rotation of the spool 25. One or more sequentially meshed speed change gears 47b, 47c, and 47d, are provided having sizes and an arrangement designed according to conventional practice to translate rotation of the circular toothed gear 47a, at a given speed, to turning of the generator spindle 46, at an appropriate rate for efficient generation of electric power. It is preferred that the transmission means include rotational direction interruption means, such as a pair of biased pawls 50 pivotally mounted at opposite ends of a prism plate 52 and a cup gear 55 having an inner wall. The prism plate 52 is attached to a drive gear 56 in synchronous rotation. The rotational direction interruption means is a link in the mechanical transmission between the spool 25 and the generator 40, which is completed by speed change gears 47b, 47c, and 47d, namely an initial gear 47b, a tandem gear 47c and a final gear 47d, see FIG. 3. The final gear 47d engages a toothed crown 58 on the spindle 46. The prism plate 52 is rotatably mounted inside the cup gear 55. The inner wall is provided with a unidirectional teeth groove 57, within the pivotal scope of the pawls 50. It is preferred that the gears comprising the transmission means be rotatably mounted on bosses 60 provided inside the housing, in a conventional manner. It is intended that the transmission means is arranged so that the pawls 50 engage the unidirectional teeth groove 57, so as to turn the generator 40 when the spool 25 is rotated in the first direction of rotation and disengage so as to interrupt transmission of motive force and to not turn the generator 40, when the spool 25 is rotated opposite the first direction of rotation. It is intended that the energy exerted by the pet in pulling the leash cord 35 is harnessed to turn the generator 40 but the work done by the spring 30, in retracting the leash cord 35, is not diverted to the turning of the generator 40. The transmission means operates to turn the generator 40 in one direction only and thereby to generate direct current at the electrical output of the generator 40. It will be appreciated that other rotational direction interruption means may alternatively serve the present invention; for example, a conventional rotary clutch may be configured to translate rotation in one direction only.

The direct current from the generator 40 is output to the circuit board 45 by conductive material such as electric wire. The circuit board 45 preferably includes power storage means such as a system of capacitors 65 conventionally arranged to store electric potential and an electric filter 70 also of conventional design configured to output a stable power supply. It is preferred that the electric filter 70 be configured to prevent discharge of electric potential to the generator 40 during idle periods.

A lamp 80, is provided on the housing 10. The output of the circuit board 45 is electrically connected, preferably by electric wires, to the lamp 80. The lamp 80 is mounted on the housing 10 and preferably includes a light bulb 85 or light emitting diode (LED) (not shown) mounted in a fixture with suitable conventional reflector and lens to provide directed illumination.

It is preferred that the housing 10 include a conventional finger operated brake (not shown) configured to jam the opening 36 and prevent further paying out of the leash cord 35, when a trigger is depressed. The trigger is preferably spring biased so as to release when finger pressure is removed. It is also preferred that the output from the circuit board 45 be controllable by a switch 90 of conventional design, for selectively energizing the lamp 80. It is intended that the switch 90 be mounted on the housing 10 for convenient access by the owner.

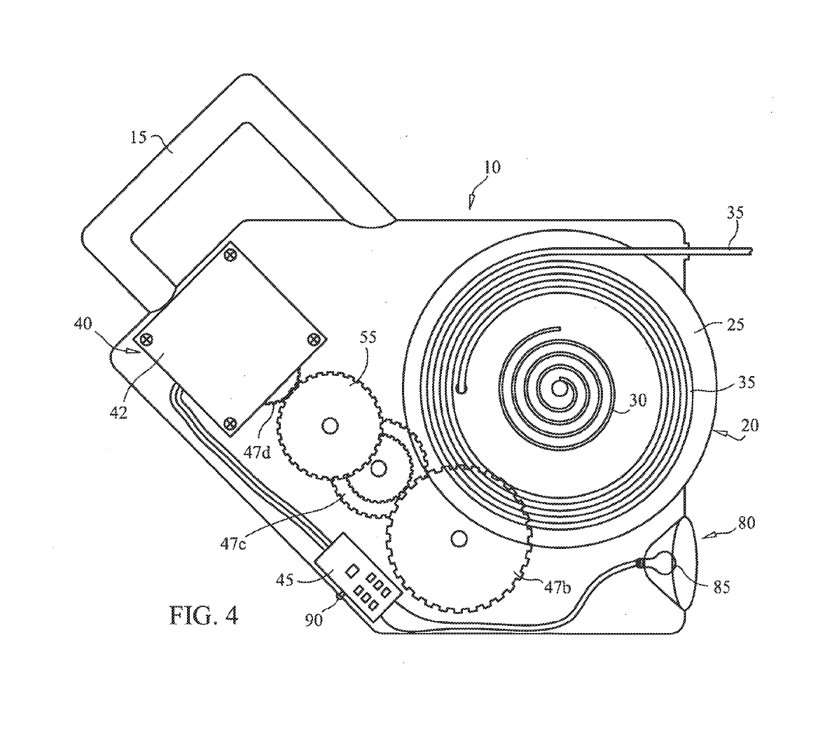

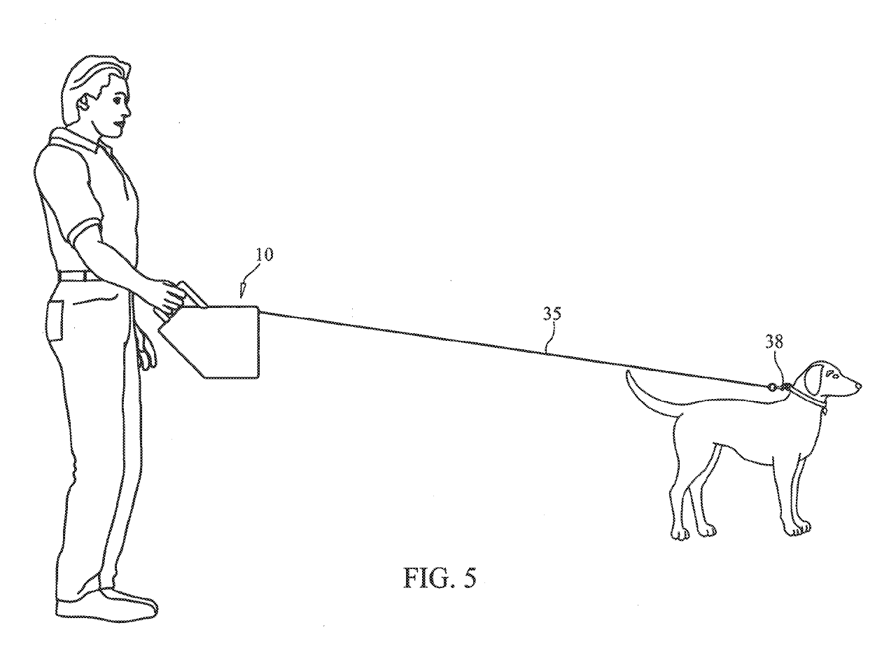

In use a pet owner may attach the clasp 38 on the second end of the leash cord 35 to a ring provided on a collar worn by a pet and grasp the handle 15 to control the pet, as shown in FIG. 5. The pet may be allowed to move away from the owner and to pay out the leash cord 35, which movement operates the generator 40 to charge the capacitors 65 on the circuit board 45. The owner may retrieve the pet to close proximity, allowing the leash cord 35 to be retracted by action of the spring 30. Shortly, the owner may again allow the pet to move away, which additionally charges the capacitors 65. The circuit board 45 outputs a stable direct current power supply to the lamp 80 for lighting the way of the owner and for serving as a beacon to nearby traffic.

The retractable pet leash with self powered electric light does not require a battery, for operation and does not require recharging through an independent apparatus. The housing 10 of the present invention, may be constructed with a relatively narrow profile, because it is not necessary to make accommodation for a battery compartment; therefore, the retractable pet leash with self powered electric light, of the present invention is relatively more convenient to transport and store than similar lighted retractable leashes of the prior art.

Further embodiments of the present invention may be constructed which provide a narrow profile. Some of these embodiments are shown in FIGS. 6 through 8. It should be appreciated that FIGS. 6 through 8 depict the reel and generator assemblies only for simplicity. In other words, the embodiments include additional elements described above, such as a housing, a circuit board, and electric power storage means and a lamp; however, such elements are not shown in the figures for the purpose of simplification. The embodiments shown in FIGS. 6 through 8 have a narrow profile due to the arrangement of the generator assembly which includes an integrated one clutch. Thus, generator assembly 100 includes an integrated one way clutch which may function in a similar fashion as the one way clutch described supra. Such an arrangement minimizes the number of parts, in particular gears, used within the system, thereby reducing cost, assembly time and assembly size. In some embodiments, generator assembly 100 does not include a one way clutch; however, such embodiments require power management electronics within the circuit board as an alternating current will be produced by generator assembly 100. As can be seen in FIG. 8, in a preferred embodiment, generator assembly 100 is positioned substantially within the axial width of reel assembly 102. In other words, axial width 104 is positioned substantially within axial width 106. It should be appreciated that substantially within is intended to mean that axial width 104 is either fully within axial width 106, or in the alternative, a significant portion of axial width 104 is within axial width 106, e.g., more than 50% of axial width 104 is within axial width 106.

It should be further appreciated that the speed changing gears described above have been substituted by the arrangement of gear 108 of reel assembly 102 and gear 110 of generator assembly 100. Thus, a single rotation of gear 108 results in several rotations of gear 110. In other words, a single rotation of reel assembly 102 provides the necessary multiple rotations of generator assembly 100 such that sufficient energy is generated to power the lamp. It should be appreciated that the rotational speed change between reel assembly 102 and generator assembly 100 may be controlled by varying the number of teeth on gear 108 and gear 110, i.e., increasing the number of teeth on gear 108 or decreasing the number of teeth on gear 110 will increase the rotational speed ratio between reel assembly 102 and generator assembly 100, while decreasing the number of teeth on gear 108 or increasing the number of teeth on gear 110 will decrease the rotational speed ratio between reel assembly 102 and generator assembly 100.

In view of the foregoing, it should be appreciated that reel assembly 102 rotates about axle 31 as leash 35 is payed in and out of housing 10. As described above, the pet draws leash 35 out of housing 10, while spring 30 draws leash 35 into housing 10. The rotation of reel assembly 102 which includes gear 108 causes gear 110 of generator assembly 100 to rotate. In the embodiments where generator assembly 100 includes a one way clutch, as leash 35 is drawn out of housing 10, electric power is generated, while no power is generated as leash 35 is drawn in. Contrarily, in the embodiments where generator assembly 100 does not include a one way clutch, electric power is generated while leash 35 is both drawn in and out of housing 10. As described above, the electric power generated by generator assembly 100 is provided to a circuit board which includes power storage means, and subsequently provides the electric power to the lamp. It should be appreciated that the axial width of gear 110 is slightly larger than the axial width of gear 108, and as such, permits some lateral movement of generator assembly 100 relative to reel assembly 102 without loss of gear to gear alignment. It should be further appreciated that axle 31 may be formed by a single bolt, and in such embodiments, the bolt may be used to two halves of housing 10 together.

It should be still yet further appreciated that the present invention may be produced in an embodiment having a rechargeable battery disposed in a compartment provided inside the housing. In this embodiment, conventional circuitry designed to charge the battery, from the output of a circuit board, is provided and connected by electric wire to terminals within the battery compartment.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A retractable pet leash with a self powered electric light comprising:
a housing, having a handle and an opening;
a leash cord, having a first end and a second end;
a reel assembly;
a generator assembly; and
a lamp;
said reel assembly comprising a spool rotatably mounted inside said housing, and a spring;
said leash cord being coiled on said spool for paying out through said opening, by rotating said spool in a first direction;
said first end of said leash cord being anchored to said spool and said second end of said leash cord being disposed outside said housing;
said spring being mounted inside said housing and being configured to bias said spool toward rotation opposite said first direction, for retracting said cord onto said spool;
said generator assembly being mounted inside said housing and comprising an electric generator, mechanical transmission means operably connecting said reel assembly to said generator and a circuit board;
said generator having an electric power output electrically connected to said circuit board;
said circuit board having electrical power storage means and electric filtering means for outputting a stable power supply;
said lamp being mounted on said housing and having electrical connection means for receiving said power supply;
whereby a user may attach a collar worn by a pet to the second end of said leash cord, grasp said handle to control said pet, and repeatedly extend and retract said cord to generate electricity for illuminating said lamp, to provide light.

2. The retractable pet leash with a self powered electric light of claim 1 wherein:
said mechanical transmission means comprises a set of sequentially meshed speed change gears configured to translate rotation of said spool to turning of said generator.

3. The retractable pet leash with a self powered electric light of claim 2, wherein said mechanical transmission means further includes rotational direction interruption means for translating rotation of said spool to said generator in one direction only.

4. The retractable pet leash with a self powered electric light of claim 3, wherein said rotational direction interruption means comprises:
a cup gear having an inner wall;
a prism plate rotatably mounted inside said cup gear;
a pair of biased pawls pivotally mounted at opposite ends of said prism plate;
a drive gear attached to said prism plate for synchronous rotation;
said inner wall having a unidirectional teeth groove within the pivotal scope of said pawls;
said drive gear being sequentially meshed with said transmission means so as to translate rotation from said cup gear to said generator in one direction only.

5. The retractable pet leash with a self powered electric light of claim 1, wherein said electric power storage means comprises a system of capacitors configured for storing electric potential.

6. The retractable pet leash with a self powered electric light of claim 1, wherein said electric power storage means comprises a rechargeable battery operably connected on said circuit board.

7. The retractable pet leash with a self powered electric light of claim 1, wherein said lamp comprises an electric light bulb for providing light.

8. The retractable pet leash with a self powered electric light of claim 1, wherein said lamp comprises a light emitting diode for providing light.

9. A retractable pet leash with a self powered electric light comprising:
a housing, having a handle and an opening;
a leash cord, having a first end and a second end;
a reel assembly having a first axial width and comprising a spool and a spring, the spool rotatably mounted inside the housing, the leash cord being coiled on the spool for paying out through the opening by rotating the spool in a first direction, the first end of the leash cord being anchored to the spool and the second end of the leash cord being disposed outside the housing, the spring being mounted inside the housing and being configured to bias the spool toward rotation opposite the first direction, for retracting the cord onto the spool;
a generator assembly being mounted inside the housing and comprising an electric generator operably connected to the reel assembly and operably connected to a circuit board, the generator having a second axial width positioned substantially within the first axial width, the circuit board having an electric power storage means; and,
a lamp mounted on the housing and being operably connected to the circuit board,
whereby a user may attach a collar worn by a pet to the second end of the leash cord, grasp the handle to control the pet, and repeatedly extend and retract the cord to generate electricity for powering the lamp.

10. The retractable pet leash with a self powered electric light of claim 9, wherein the generator assembly further comprises a one-way clutch arranged to translate rotation of the spool to the generator in a single direction only.

11. The retractable pet leash with a self powered electric light of claim 9, wherein the electric power storage means comprises at least one capacitor configured for storing electric potential.

12. The retractable pet leash with a self powered electric light of claim 9, wherein the electric power storage means comprises at least one rechargeable battery configured for storing a charge.

13. The retractable pet leash with a self powered electric light of claim 9, wherein said lamp comprises an electric light bulb or a light emitting diode for providing light.

14. A retractable pet leash with a self powered electric light comprising:
a reel assembly having a first axial width;
a generator assembly comprising an electric generator operably connected to the reel assembly and operably connected to a circuit board, the generator having a second axial width positioned substantially within the first axial width, the circuit board having an electric power storage means; and,
a lamp operably connected to the circuit board,
whereby a rotation of the reel assembly generates electricity for powering the lamp.
